(19) United States
(12) Patent Application Publication
(10) Pub. No.: US 2010/0027716 A1
(43) Pub. Date: Feb. 4, 2010

(54) AUTONOMOUS CONTROL UNIT AND RECEIVER USING THE SAME

(75) Inventor: Shigeru Amano, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/507,839

(22) Filed: Jul. 23, 2009

(30) Foreign Application Priority Data
Jul. 30, 2008 (JP) 2008-196875

(51) Int. Cl. H04B 1/06; H04L 7/00

(52) U.S. Cl. 375/316; 375/354; 375/260

(57) ABSTRACT

An autonomous control unit includes an input stage register section, a computation section, and an output stage register section. The input stage register section includes plural input stage registers, and acquires, at a first timing, data indicating a given reception status of an incoming signal. The computation section performs comparison computation with respect to the data acquired by the input stage register section, performs logic processing of a set number of cycles of sequential control on the comparison computation result, and derives a logic processing result. The output stage register section includes at least one output stage register, and outputs a control value from the logic processing result at a second timing.

### CROSS-REFERENCE TO RELATED APPLICATION

This application claims priority under 35 USC 119 from Japanese Patent Application No. 2008-196875, filed on Jul. 30, 2008, the disclosure of which is incorporated by reference herein.

### BACKGROUND OF THE INVENTION

1. Field of the Invention

The present invention relates to a programmable autonomous control unit that autonomously acquires given data in, for example, a communications device, and performs control of a component subject to control that is internal or external to the device, and to a receiver using the same.

2. Description of the Related Art

Currently, the range of devices installed with systems using wireless communication is expanding to devices operated by battery power such as mobile phones, portable audio devices, and the like. Such devices are referred to below as “mobile devices”, and since such mobile devices are required to be easily portable, there are also demands for extremely compact transceiver devices therefor, and sometimes even the shape of the antenna, which imparts a great influence on the transceiving characteristics of wireless devices, is subject to many restrictions. Therefore, not only excellent characteristics required for a transceiver unit, but also operating the transceiver device in a well balanced manner within such restrictions has become extremely important.

Technology relating to such transceiver devices installed in mobile devices is described, for example, in Japanese Patent Application Laid-Open (JP-A) No. 2006-270582.

FIG. 10 is a schematic configuration diagram showing a related receiver as described in JP-A No. 2006-270582.

The receiver is, for example, a receiver installed in a mobile device for terrestrial digital broadcasting use, and has an antenna 1. A Low Noise Amplifier (referred to below as “LNA”) 2 with ON/OFF control is connected to the antenna 1. The LNA 2 is a circuit in which ON/OFF operation is performed based on an enable control signal EN. A receiver main unit 4 is connected to the output side of the LNA 2 via a frequency band filter 3.

The receiver main unit 4 includes: a radio frequency receiver 4a (referred to below as “RF” receiver); an Orthogonal Frequency Division Multiplexed signal demodulating and Forward Error Correction section 4b (referred to below as OFDM-FEC section) that performs demodulation and Forward Error Correction (FEC) on a signal modulated by Orthogonal Frequency Division Multiplexing (OFDM); a register section 4c having plural registers (REG); and a General Purpose Input/Output port (referred to below as “GPIO”) 4d. The OFDM-FEC section 4b demodulates an output signal of the RF receiver 4a, performs error correction and the like, and outputs a transport stream (TS) signal. The GPIO 4d is a circuit that outputs an enable control signal EN based on the output signal of the register section 4c in order to control ON/OFF operation of the LNA 2.

A backend device (BE) 5 is connected to the output side of the OFDM-FEC section 4b. Further, an application processor 6 is connected to the register section 4c, via an external bus interface 7 (for example an I²C interface, which is a serial bus). The backend device 5 includes a TS decoder and an AAC decoder of video compression standard (H.264). The application processor 6 has the functionality of a Host Central Processing Unit (referred to below as CPU) that performs control of applications as a whole.

The receiver configured in this manner operates as set out below.

The RF signal received from the antenna 1 is amplified, passed straight through, or attenuated in the LNA 2 at a preceding stage of the receiver main unit 4, to a reception power that can be easily received by the receiver main unit 4 at a following stage. After amplification, passing straight through, or attenuation, only the desired band is extracted by the frequency band filter 3, and input to the receiver main unit 4.

The preceding stage devices (LNA 2 and frequency band filter 3) may be included in the receiver main unit 4. However, since there are many digital processing circuits present in the receiver main unit 4, the receiver main unit 4 generally uses processes that can be performed by a compact structure with low power consumption suitable for digital processing. Therefore, the LNA 2 at the initial stage to which an extremely high noise figure (NF) is required, the frequency band filter 3 which may become extremely large in order to attain favorable characteristics when included in the receiver main unit 4, and the like may be provided as a separate device in practical configuration. In addition, from the perspective of product planning, such preceding stage devices are not always provided.

In the RF receiver 4a in the receiver main unit 4, after the RF signal is frequency converted to the base band signal, filtering is performed in order to extract only the desired band frequency, digital conversion is carried out, and the signal is sent to the OFDM-FEC section 4b. The OFDM-FEC section 4b performs OFDM demodulation, error correction (decoding) to the coding performed at the transmission side, and deinterleaving computations, and outputs a TS signal to the backend device 5. The backend device 5 generates an image or audio signal, and performs data signal processing and the like. Control of the receiver main unit 4 is generally performed by the application processor 6 via the I²C interface 7.

In order to improve reception sensitivity and to suppress power consumption, the LNA 2 with ON/OFF control is provided at the preceding stage of the receiver main unit 4. This ON/OFF control is performed by the application processor 6 by reading out the register of the receiver main unit 4 that can estimate the reception power, and changing the voltage supplied to the LNA2 by the GPIO 4d through the register in the register section 4c of the receiver main unit 4, or by the GPIO 4d of the application processor 6, such that the LNA 2 is turned OFF when the reception power is high, and the LNA 2 is turned ON when the reception power is low and determined to be in a region for performing reception sensitivity enhancement.

Explanation below is described on the basis that the GPIO 4d in the receiver main unit 4, which is generally used, is employed for the ON/OFF control.

In such a configuration, control is performed by the following procedures (1) to (4).

(1) Readout from a register in the register section 4c of the receiver main unit 4 representing internal data.

(2) Computation is performed by the application processor 6 on this data when computation is possible.

(3) The computation result is written, by the GPIO 4d in the receiver main unit 4, to a register in the register section 4c that generates an enable control signal EN.

(4) The control gain (gain) of the LNA 2 with ON/OFF control is switched over according to the enable control signal EN from the GPIO 4d.

However, the conventional receiver shown in FIG. 10 has the following issues (a) to (c). These issues cause performance issues in a closed loop having a feedback operation such as used in a receiver.

(a) In control by the application processor 6, the computation timing cannot be set, and there is no guarantee that appropriate computation will occur at the computation timing. Namely, there is no guarantee that input values for the computation are appropriate.

(b) In control by the application processor 6, there is no guarantee that the timing of control performed after the computation will be an appropriate timing for the receiver. Namely, there is no guarantee that the output control value is appropriate at that time.

Frequent operation of the I²C interface 7 between the application processor 6 and the receiver main unit 4 during reception is not desirable due to concern regarding the influence of interference on the RF signal of the RF receiver 4a.

In addition, in the receiver described in JP-A No. 2006-270582, the gain of the LNA 2 is controlled based on the control signal from the application processor 6. However, as stated above, considering that the LNA 2 is usually an external device of the receiver main unit 4, if the configuration of the receiver main unit 4 is adjusted to the characteristics of a particular LNA 2, it cannot accommodate an LNA 2 of a different manufacture or different product. Furthermore, there are cases in which since the response characteristics of the LNA 2 impart an influence to different locations in the reception path, control is also required to the affected locations. However, since the receiver described in JP-A No. 2006-270582 does not have scalability, such issues cannot be addressed.

### SUMMARY OF THE INVENTION

In consideration of the above circumstances, the present invention provides an autonomous control unit that performs control appropriately, and a receiver using the same.

An aspect of the present invention is an autonomous control unit including: an input stage register section that includes plural input stage registers, and acquires, at a first timing, data indicating a given reception status of an incoming signal; a computation section that performs comparison computation with respect to the data acquired by the input stage register section, performs logic processing of a set number of cycles of sequential control on the comparison computation result, and derives a logic processing result; and an output stage register section that includes at least one output stage register, and that outputs a control value from the logic processing result at a second timing.

Another aspect of the present invention is a receiver including a single autonomous control unit according to the above aspect, or plural the autonomous control unit according to the above aspect disposed in parallel, wherein the reception status is controlled by the control value output from the autonomous control unit.

### BRIEF DESCRIPTION OF THE DRAWINGS

Exemplary embodiments of the present invention will be described in detail based on the following figures, wherein:

FIG. 1 is a schematic configuration diagram showing an autonomous control unit 30 of a first exemplary embodiment;

FIG. 2A and FIG. 2B are schematic configuration diagrams showing a receiver of the first exemplary embodiment;

FIG. 3 is a timing chart showing reception processing of the receiver of FIG. 2 on an OFDM signal;

FIG. 4 is a detailed configuration diagram showing an autonomous control unit 30 of the receiver of FIG. 2;

FIG. 5 is a timing chart showing an example of control of the autonomous control unit 30 of the receiver of FIG. 2;

FIG. 6 is a schematic configuration diagram showing a receiver of a second exemplary embodiment;

FIG. 7 is a timing chart showing reception processing of the receiver of FIG. 6 on an OFDM signal;

FIG. 8 is a detailed configuration diagram showing an autonomous control unit 30 of the receiver of FIG. 6;

FIG. 9 is a detailed configuration diagram showing another autonomous control unit 30 of the receiver of FIG. 6; and

FIG. 10 is a schematic configuration diagram showing a conventional receiver.

### DETAILED DESCRIPTION OF THE INVENTION

Herebelow, exemplary embodiments of the present invention will be described with reference to the attached drawings. It should be noted that the drawings are for ease of explanation, and do not intended to limit the scope of the present invention.

### First Exemplary Embodiment

### Receiver of a First Exemplary Embodiment

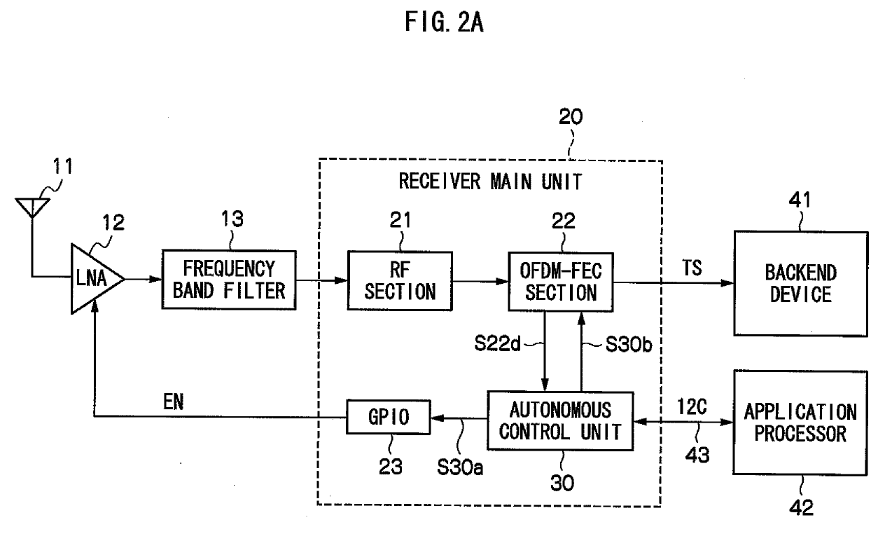

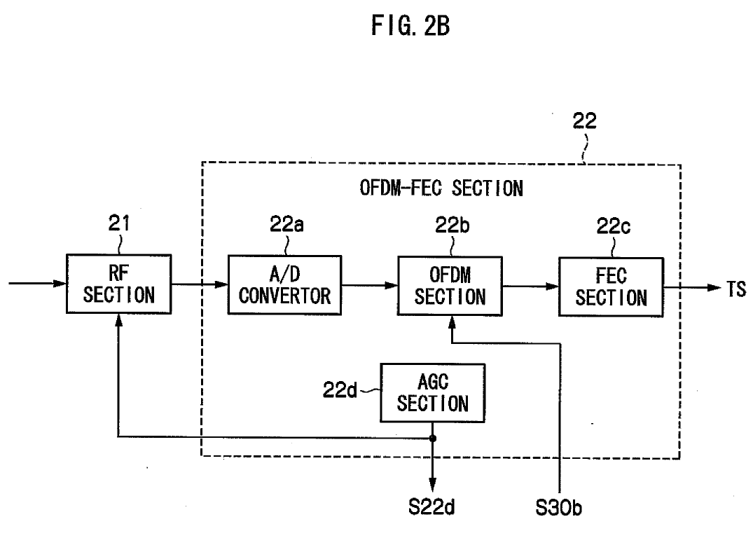

FIGS. 2A and 2B are schematic configuration diagrams showing a receiver of the first exemplary embodiment. FIG. 2A is a configuration diagram of the overall structure of the receiver, and FIG. 2B is a configuration diagram of an OFDM-FEC section in the receiver.

The receiver is, for example, a receiver installed in a mobile device for terrestrial digital broadcasting use. The receiver includes an antenna 11 that receives an OFDM modulated RF signal, and an LNA 12 with ON/OFF control is connected to the antenna 11. The LNA 12 with ON/OFF control is turned ON/OFF by an enable control signal EN, and is a circuit that performs amplification, straight throughput, or attenuation on the received RF signal. A frequency band filter 13 is connected to the output side of the LNA 12. The frequency band filter 13 is a circuit that extracts from the output signal of the LNA 12 only the RF signal of the desired frequency band. A receiver main unit 20 is connected to the output side of the frequency band filter 13.

The receiver main unit 20 includes an RF section 21, an OFDM-FEC section 22, an autonomous control unit (ACU) 30, a GPIO 23 and the like.

The RF section 21 is a circuit that selects the physical channel when input with the output signal of the frequency band filter 13, performs signal amplification based on control value S22d of automatic gain control (referred to below as “AGC”), and outputs an analogue base band single to the OFDM-FEC section 22. The OFDM-FEC section 22 is connected to the output side of the RF section 21.

The OFDM-FEC section 22 includes an analogue-digital converter (referred to below as “A/D converter”) 22a, an OFDM section 22b, an FEC section 22c, the AGC section 22d, and the like. The A/D converter 22a converts the analogue baseband signal into a baseband signal of a digital signal. The OFDM section 22b performs Fast Fourier Transformation (referred to below as “FFT”) processing on the digital baseband signal, based on an OFDM section control signal S30b, and demodulates and converts the digital baseband signal into a TS signal. The FEC section 22c performs error correction on the TS signal. The AGC section 22d outputs the AGC control value S22d for controlling the degree of amplification. The autonomous control unit (ACU) 30 is connected to the OFDM-FEC section 22.

The autonomous control unit 30, based on the AGC control value S22d and the like, may output a single-bit of a LNA control signal S30a for ON/OFF control of the LNA 12, and a single-bit of the OFDM section control signal S30b. The GPIO 23 is connected to the output side of the autonomous control unit 30. The GPIO 23 is a circuit that, based on the LNA control signal S30a, outputs the enable control signal EN and operates the LNA 12 to be turned ON or OFF.

A backend (BE) device 41 is connected to the output side of the OFDM-FEC section 22 in the receiver main unit 20. An application processor 42 is also connected to the receiver main unit 20 via an external bus interface (for example, an I²C interface, which is a serial bus) 43. The backend device 41 includes a TS decoder, an H.264 standard AAC decoder and the like, and is a circuit that decodes (demodulates) a TS signal, reproducing an image and/or audio signal, and performing digital signal processing. The application processor 42 functions as a host CPU that performs control of application program(s) of the receiver as a whole including the receiver main unit 20.

The receiver configured as above is operated as set out below. In terrestrial digital television broadcasting, for example, when an OFDM modulated signal arrives, this RF signal is received by the antenna 11. The RF signal is amplified, passed straight through, or attenuated in the LNA 12 with ON/OFF control at a stage prior to the receiver main unit 20, in order to give a reception power that the receiver main unit 20 can easily perform reception process at a later stage. Then the desired frequency band alone is extracted by the frequency band filter 13, and input to the receiver main unit 20.

In the receiver main unit 20 the physical channel is selected by the RF section 21 from the output signal of the frequency band filter 13, signal amplification is performed thereon, and an analogue baseband signal is output. The analogue baseband signal is converted into a digital baseband signal by the A/I) converter 22a in the OFDM-FEC section 22, demodulated by FFT processing by the OFDM section 22b, and converted into a TS signal. Further, error correction and the like of the TS signal is performed by the FEC section 22c and the signal is output to the backend device 41. Reproduction of an image and/or audio signal, and digital signal processing and the like is performed by the backend device 41.

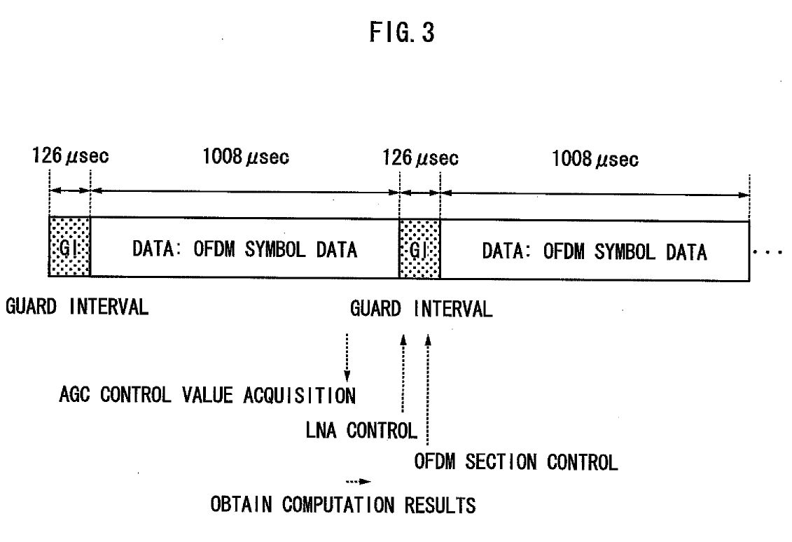

FIG. 3 is a timing chart showing reception processing of the receiver of FIG. 2 on an OFDM signal transmitted, for example, in terrestrial digital television broadcasting.

Terrestrial digital broadcasting is a broadcasting method that uses OFDM, and a guard interval (GI) segment and an OFDM symbol data (DATA) segment are present in the OFDM signal. There are often cases where there is a qualitative difference in the influence from OFDM demodulation by a reception system in the GI segment and in the DATA segment. Therefore, in control that might influence the reception system precise timing adjustment is required. There is also a case that computation result is affected due to the acquisition timing of the OFDM signal, and therefore, control may be stabilized by ensuring the signal is acquired at a set timing.

With respect to this, the autonomous control unit 30 of the first exemplary embodiment computes a specific computation result at an acquisition timing of a signal from the OFDM-FEC section 22 (for example, at the acquisition timing of the AGC control value S22d from the AGC section 22d), and outputs the LNA control signal S30a to the GPIO 23. After the enable control signal EN has been output from the GPIO 23 and the LNA 12 has been ON/OFF controlled, the OFDM section control signal S30b is output to the OFDM section 22b at a timing that influences the later stages (i.e., at a timing when the signal arrives at the later stages), and control of the OFDM section 22b, which is a separate component, is executed after a set delay. Namely, in the autonomous control unit 30, the acquisition timing of the AGC control value S22d, the timing of LNA control, and the timing of OFDM section control can be adjusted by a simple program.

Normally, such precise determinations of the acquisition timing of a signal and control timings of each section, cannot be performed in the application processor 42 that performs processing via an external bus interface (for example, I² interface). Instances also occur where the latency (delay period) from after acquisition of the signal till the control timing is not constant due to other processing, and sometimes control may not be performed on time. Such situations are addressed by the autonomous control unit 30 of the first exemplary embodiment.

### Autonomous Control Unit of the First Exemplary Embodiment

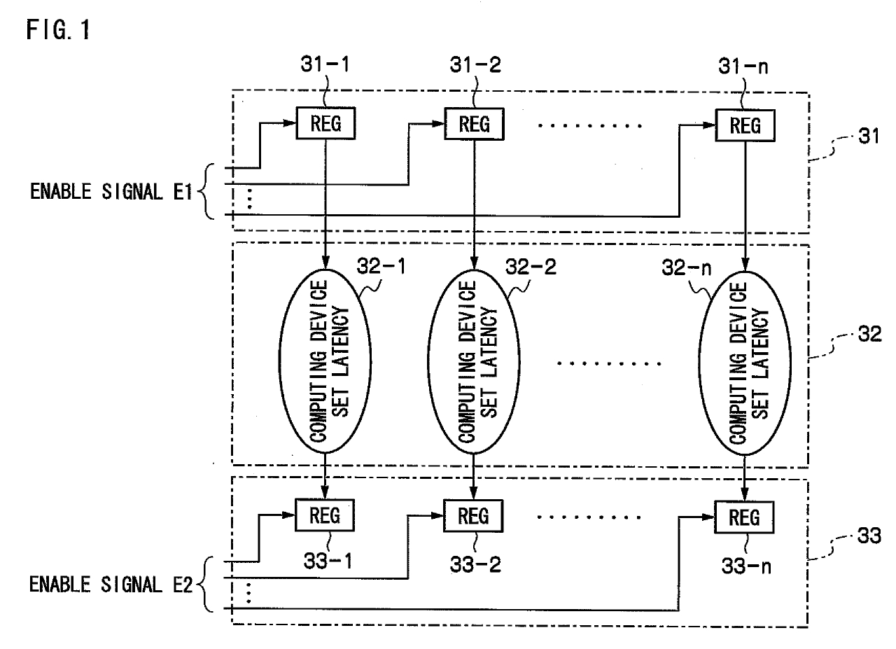

FIG. 1 is a schematic configuration diagram showing the autonomous control unit 30 of the receiver of FIG. 2 according to the first exemplary embodiment.

The autonomous control unit 30 includes an input stage register section 31, a computing section 32, and an output stage register section 33. The input stage register section 31 includes plural registers (REG) 31-1 to 31-n that respectively perform shift operations according to an enable signal E1. The computing section 32 includes plural computing devices 32-1 to 32-n that perform logic computations on an output signal of the input stage register section 31 with a respective set (constant) latency. The output stage register section 33 has plural output stage registers 33-1 to 33-n that respectively perform shift operations on the computation result of the computing section 32 according to an enable signal E2.

The input stage registers 31-1 to 31-n acquire internal data of the receiver main unit 20, such as, the AGC control value S22d, with a first timing of the enable signal E1. The enable signal E1 can be generated as a result of the receiver main unit 20 having a function that can shift by a set amount of time from a reference timing always held by the receiver, such as a single symbol reference timing, a single frame reference timing, and the like. Thereby, the signal (AGC control value) acquisition timing, as shown in FIG. 3 can be realized.

Specifically, the reference timing is selected and input to the autonomous control unit 30, and the input stage register section 31 is controlled at a timing at which the input reference timing is shifted by a set time. When this is done, the plural input stage registers 31-1 to 31-n may be controlled with the same enable signal E1 timing, or may be controlled respectively with an enable signal E1 of different timing. Computation is performed with a set latency by the computing section 32 of the next stage, based on the value acquired by the input stage register section 31, and the computation result is sent to the output stage register section 33. The output stage register section 33 outputs the computation result of the computing section 32 based on the enable signal E2 (i.e., outputs, for example, the LNA control signal S30a and the OFDM section control signal S30b with a specific timing).

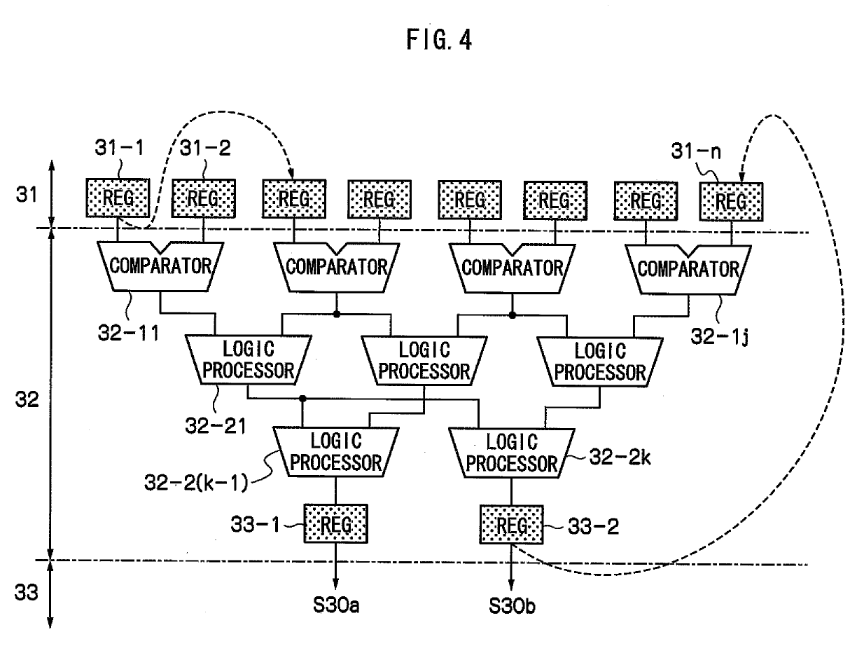

FIG. 4 is a detailed configuration diagram showing a modification of the autonomous control unit 30 in the receiver of FIG. 2.

The autonomous control unit 30 includes an input stage register section 31 with plural input stage registers 31-1 to 31-n as in FIG. 1, a computing section 32 connected to the register section 31, and an output stage register section 33 with two output stage registers 33-1, 33-2 connected to the computing section 32. The computing section 32 has plural comparators 32-11 to 32-1j (where j=n/2) that perform comparisons between the register values of the input stage registers 31-1 to 31-n, and plural logic processors 32-21 to 32-2k that are connected to the comparators 32-11 to 32-1j in a tree structure.

The two output stage registers 33-1, 33-2 of the output stage register section 33 are respectively connected to the output side of the two logic processors 32-2(k−1) and 32-2k in the last stage of the computing section 32. Control output signals (for example the LNA control signal S30a and the OFDM section control signal S30b) are output from the two output stage registers 33-1, 33-2.

In operation of the autonomous control unit 30 of FIG. 4, internal data of the receiver main unit 20, such as, for example, the AGC control value S22d, is acquired in the input stage registers 31-1 to 31-n with a timing of the enable signal E1. Computation is performed with a set latency by the computing section 32 based on the values acquired. These computations may be logical operations such as, for example, comparative operations to a given value (≦, ≧, =, >, <), logical conjunctions thereof (referred to as “AND” below), logical disjunctions thereof (referred to as “OR” below), exclusive disjunctions thereof (referred to as “XOR” below), inversions thereof (referred to as “INV” below), and the like. Computation results can be obtained by these computations for control output using the GPIO 23 directed to LNA control and the like with extremely short latency.

It is also possible for an input stage register (for example 31-3) to obtain a value from another input stage register (for example 31-1), and thereby, comparison to the state prior to the current acquisition timing, for example, is possible. In addition, an input stage register (for example 31-n) can obtain the output signal of an output stage register (for example 33-2). Consequently, algorithms and values for comparisons at the logic processors can be changed depending on whether the current control status of the output stage register is either a logical 0 or 1.

By providing a programmable configuration such that the behavior of each of the registers 31-1 to 31-n, 33-1, 33-2 and each of the logic processors 32-21 to 32-2k can be designated from the external application processor 42, implementation of control other than the control of ON/OFF switchable LNA of the first exemplary embodiment, and implementation of control using a separate algorithm and the like, can readily be made. In addition, since in each of the sequences in the vertical direction of the autonomous control unit 30, a desired output signal from the previous stage can be selected and input, a desired computation can be performed.

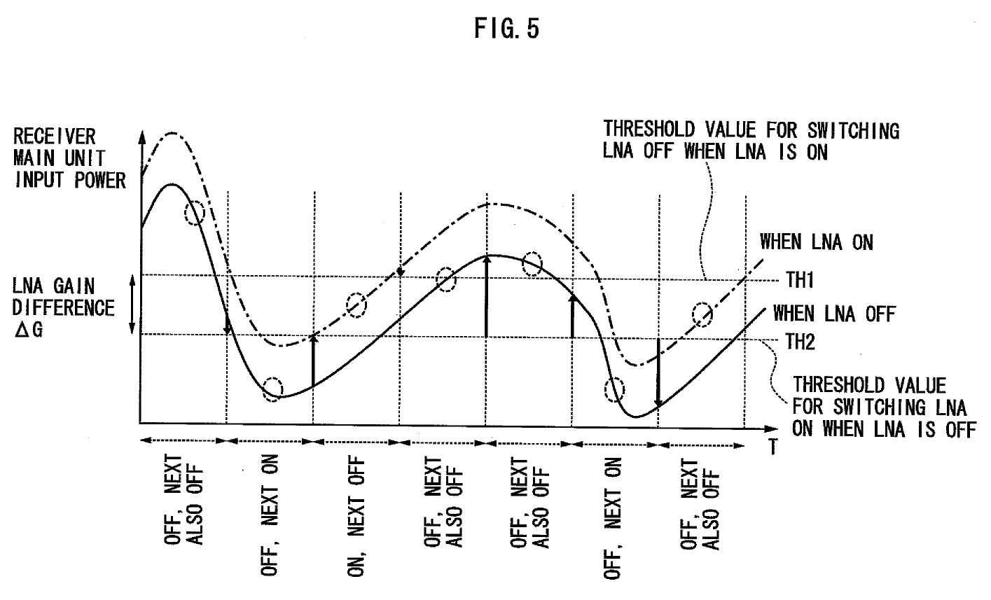

In the autonomous control unit 30 the enable signal E2, with a separate timing to that of the enable signal E1 of the input stage, is applied to the output stage registers 33-1, 33-2 which outputs the computation result. This thereby enables, for example, to configure one output stage register to be designated for use in the output of the LNA control signal S30a and one output stage register to be designated for use in the output of the OFDM section control signal S30b, and to control each output stage register at respective given timings. This thereby enables, for example, operation as shown in FIG. 5.

FIG. 5 is a timing chart showing an example of control of the autonomous control unit 30 of the receiver of FIG. 2.

The horizontal axis of FIG. 5 is the ON/OFF switching time t in the LNA 12, and the vertical axis is the input power level of the receiver main unit 20. The LNA 12 is in the OFF state on start up. FIG. 5 shows diagrammatically a threshold value TH1 for switching the LNA 12 over to OFF when the LNA 12 is ON, and a threshold value TH2 for switching the LNA 12 over to ON when the LNA 12 is OFF. The difference between the two threshold values TH1, TH2 is a gain difference Ag of the LNA 12 between when the LNA 12 is ON state and OFF state.

During the measurement periods at respective time t on the horizontal axis of FIG. 5, the input power level is compared with the threshold value TH1 or TH2 of the current mode of operation of the LNA 12, determination is made as to whether or not the operation mode transition conditions are met for half or more of the measurement period, and the operation mode for the next measurement period is determined. When the LNA 12 is ON/OFF controlled by LNA control of the autonomous control unit 30, the input power level of the receiver main unit 20 is changed by the gain difference Ag. If there were to be only one threshold value then if the LNA input power level was in the vicinity of this threshold value then a chattering ON/OFF state of the LNA 12 would occur. Having the threshold value TH2 when ON and the threshold value TH1 when OFF enables the control to be imparted with hysteresis.

According to the first exemplary embodiment, the following items (1) to (4) are enabled by use of the autonomous control unit 30.

(1) Acquisition of a value for performing control is possible at a set timing, and control computation can always obtain the intended result from an input.

(2) Timings for renewing the computation result and performing control can be controlled to be at one or more given timings, hence enabling changes to be made to the operation of the receiving system at appropriate times during reception processing. The output stage registers 33-1, 33-2 are also able to renew the output of the control values at designated timings. These timings may be associated with or not associated with the AGC control value acquisition timing or other acquisition timing of the input stage registers 31-1 to 31-n.

(3) Since computation is performed at a set (constant) latency (cycle number), the time from acquiring the value for performing control until control is actually performed is always constant. Therefore computation and control are always as intended.

(4) After receiver manufacture (for example after completion of the integrated circuit (LSI)), and even after installing each of the configuration elements in the device, each of the configuration elements can easily be made to perform the desired operation by program overwriting.

Due to such a configuration, for example, the external LNA 12 with ON/OFF control can be adaptively switched ON/OFF by the GPIO 23, and appropriate power and reception states can be generated autonomously without performing control by the application processor 42.

### Second Exemplary Embodiment

### Receiver of the Second Exemplary Embodiment

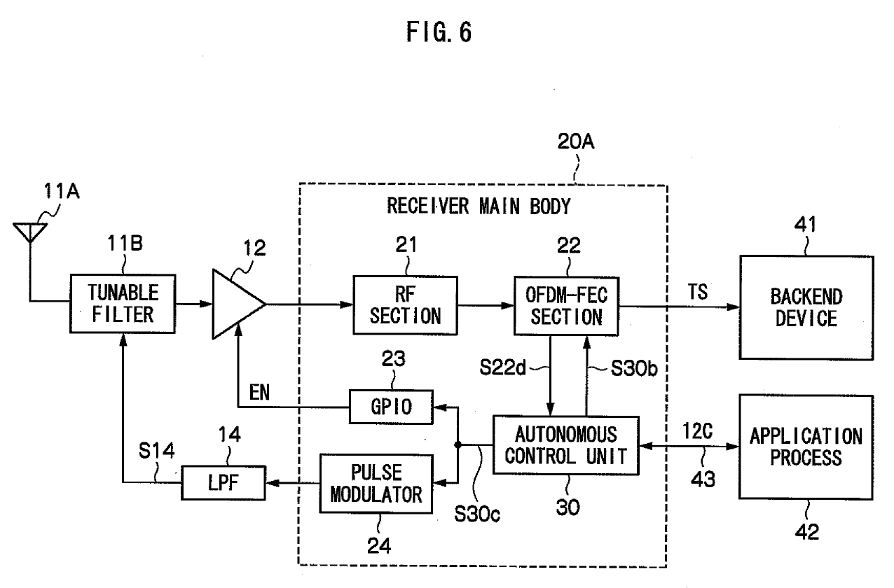

FIG. 6 is a schematic configuration diagram showing a receiver of a second exemplary embodiment, and elements therein that are common to elements in FIG. 2 showing the first exemplary embodiment are allocated common reference numerals.

The receiver of the second exemplary embodiment, similarly to that of the first exemplary embodiment, is for example a receiver installed in a mobile device for terrestrial digital broadcasting use. The receiver shown in FIG. 6 is provided with: a tunable antenna 11A and a tunable filter 11B that controls the directional characteristics of the tunable antenna 11A, in place of the standard antenna 11 of the first exemplary embodiment; and with a low pass filter (referred to as “LPF” below) 14 for controlling the tunable filter 11B using an analogue control signal S14. Furthermore, a receiver main unit 20A is provided in place of the receiver main unit 20 of the first exemplary embodiment, the receiver main unit 20A having a different configuration thereto.

The tunable antenna 11A operates with given directional characteristics according to the analogue potential input thereto. The tunable filter 11B for controlling the tunable antenna 11A operates as a filter for a desired channel, and depending on the receiving frequency settings has a high Q value for desired frequencies, and a low Q value for other frequencies.

The receiver main unit 20A has, in addition to the configuration of the receiver main unit 20 of the first exemplary embodiment, an autonomous control unit 30 provided with functionality for performing multi-bit control, and a pulse modulator 24 added for controlling the directional characteristics of the tunable antenna 11A. The pulse modulator 24 is a circuit for pulse width modulating (referred to below as “PWM”) or pulse density modulating (referred to below as “PDM”) multi-bits of a control signal S30c received from the autonomous control unit 30, and passing the modulated signal to the LPF 14. The LPF 14 is a circuit for converting the digital signal having multi-bit resolution output from the pulse modulator 24 into the analogue control signal S14, for analogue control of the tunable filter 11B.

Namely, the receiver main unit 20A in the second exemplary embodiment has functionality for performing control to the reception path from the autonomous control unit 30 (controlling the OFDM section 22b, and the FEC section 22c, and the RF section 21), and an additional functionality for converting the digital signal having multi-bits resolution that is the output signal of the pulse modulator 24, into the analogue control signal S14 by use of the LPF 14, and thereby performing control on the tunable filter 11B.

It should be noted that the GPIO 23 has a functionality for outputting an enable control signal EN using a single bit control signal from the multi-bits of the control signal S30c received from the autonomous control unit 30, and controlling the LNA 12. The OFDM section control signal S30b output from the autonomous control unit 30 has multi-bit data, and is a signal for controlling multi-bit control elements (for example, register setting values for adjustment) within the OFDM section 22b.

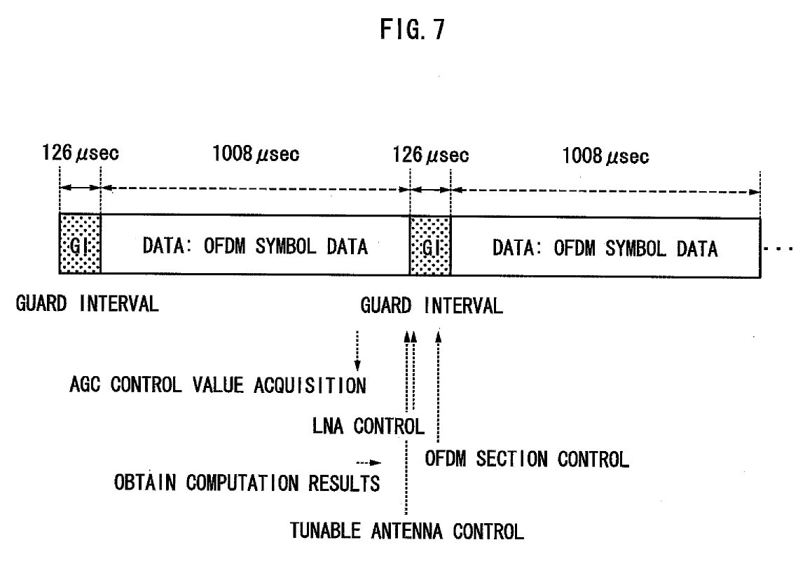

FIG. 7 is a timing chart showing reception processing of the receiver of FIG. 6 for an OFDM signal transmitted, for example, in terrestrial digital television broadcasting, and common elements to elements in FIG. 3 of the first exemplary embodiment are allocated common reference numerals.

In the timing chart in FIG. 7 there is tunable antenna control timing present prior to the LNA control timing. This is because the tunable antenna 11A and the tunable filter 11B are each provided in a stage prior to the LNA 12.

In the autonomous control unit 30 of the second exemplary embodiment, specific computation results are output at the timing of acquisition of a signal from the OFDM-FEC section 22 (for example at the timing the AGC control value S22d is acquired from the AGC section 22d), and the multi-bit OFDM section control signal S30b and multi-bit control signal S30c are output. The multi-bit OFDM section control signal S30b is applied to the OFDM section 22b. Multi-bits of the control signal S30c are applied to the pulse modulator 24, and a single bit control signal in the multi-bit control signal S30c is applied to the GPIO 23.

The analogue control signal S14 is thereby output from the pulse modulator 24 by use of the LPF 14, and the directional characteristics of the tunable antenna 11A are controlled by the tunable filter 11B. Next, in a similar manner to in the first exemplary embodiment, after an enable control signal EN is output from the GPIO 23 and ON/OFF control of the LNA 12 is performed, the OFDM section 22b is controlled by the OFDM section control signal S30b at a timing that influences a later stage (i.e., at a timing when the signal arrives at the later stages).

Consequently, in the autonomous control unit 30, the acquisition timing of the AGC control value S22d, tunable antenna control, LNA control, and OFDM section control are each adjusted by a simple program.

### Autonomous Control Unit of the Second Exemplary Embodiment

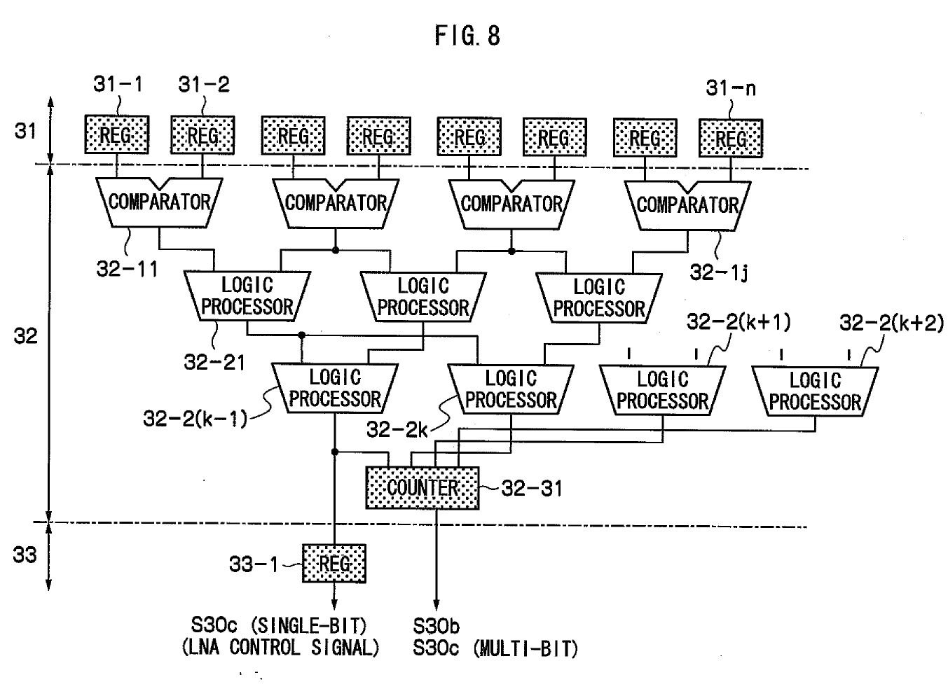

FIG. 8 is a detailed configuration diagram showing the autonomous control unit 30 of the receiver of FIG. 6, elements therein that are common to elements of FIG. 4 showing the autonomous control unit 30 of the first exemplary embodiment are allocated common reference numerals.

The autonomous control unit 30 of the second exemplary embodiment includes an input stage register section 31 including plural input stage registers 31-1 to 31-n as in FIG. 4, a computing section 32 connected to the input stage register section 31, and an output stage register section 33 having a single output stage register section 33-1 connected to the computing section 32.

The computing section 32 has plural comparators 32-11 to 32-1j that compare register values of the input stage registers 31-1 to 31-n, and plural logic processors 32-21 to 32-2(k+2) connected to the comparators 32-11 to 32-1j in a tree structure, substantially the same as in FIG. 4. Further, a counter 32-31 is added at the output side of the logic processors 32-2(k−1) to 32-2(k+2) at the last stage. The counter 32-31 is operated by increment, decrement, load-enable, and reset control inputs, and the counter output is the control timing of, for example, the multi-bit OFDM section control signal S30b and the control signal S30c. An output stage register 33-1 configuring the output stage register section 33 has functionality for outputting a single bit signal (for example the LNA control signal) from the multi-bit control signal S30c.

The enabling the input stage register section 31, enabling the output stage register section 33, and the computing section 32 of the autonomous control unit 30 shown in FIG. 8 basically operates similarly to those of the autonomous control unit 30 of the first exemplary embodiment shown in FIG. 4. Operation of the counter 32-31 added thereto can also be considered as the same.

Namely, in the operation of the autonomous control unit 30 of FIG. 8, internal data of the receiver main body 20A, for example the AGC control value S22d and the like, is acquired in the input stage registers 31-1 to 31-n at a first timing of the enable signal E1. The computations are performed by the computing section 32 with the set latency based on the acquired value. These computations includes logical operations such as, for example, comparisons to a given value, and associated AND, OR, XOR, INV operations. By these computations, computation results can be obtained for control output using the GPIO 23 directed to LNA control with extremely short latency, and in addition the computation results can be obtained for control output using the pulse modulator 24 directed to tunable antenna control. Consequently, by providing a programmable configuration such that the behavior of each of the registers 31-1 to 31-n, 33-1, 33-2 and each of the logic processors 32-21 to 32-2(k+2) can be designated from the external application processor 42, implementation of control of an ON/OFF switchable LNA and tunable antenna control and the like can readily be implemented.

In the autonomous control unit 30, an enable signal E2 of a second timing separate to that of the input stage enable signal E1, is applied to the output stage register 33-1 and the counter 32-31, which output the computation results. Thereby, for example, it is possible to allocate the output stage register 33-1 to LNA control signal output, the counter 32-31 to OFDM section control signal S30b and control signal S30c output, and to control the respective output at given timings.

The counter 32-31 may implement control of incrementing, as well as decrementing, load-enabling, and resetting, and control timing may be set according to the performed control. Thereby, the counter 32-31 may have functionalities such as instructing the initial value and an N progress counter (+ direction, − direction), and multi-bit value control is enabled. Configuration without the 0/1 binary control function of the first exemplary embodiment is also possible.

### Modified Example of the Autonomous Control Unit of the Second Exemplary Embodiment

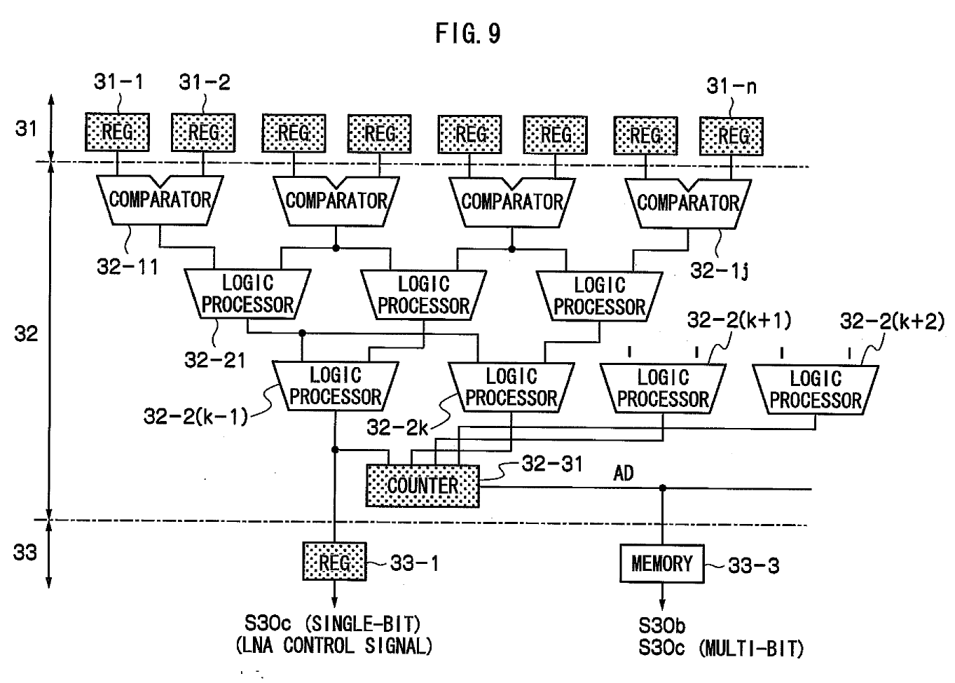

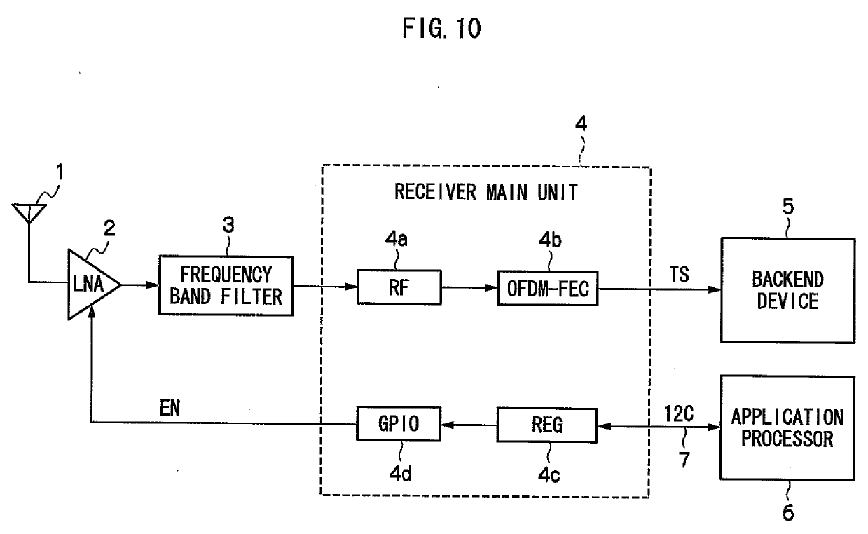

FIG. 9 is a detailed configuration diagram showing a modified example of the autonomous control unit 30 of the receiver in FIG. 6, elements therein that are common to elements of the autonomous control unit 30 in FIG. 8 are allocated common reference numerals.

In the autonomous control unit 30 of FIG. 9, a memory 33-3 configured by hardware and/or software is connected to the output side of the counter 32-31. The output of counter 32-31 operates for addressing (address specification) of the memory 33-3, and the memory 33-3 outputs, as a control output signal, data of an address AD specified by the counter 32-31. Other parts of the configuration are similar to those of FIG. 8.

Therefore, whereas in the configuration of FIG. 8 the counter output value can only controlled with a one-dimensional relationship, the configuration of FIG. 9 can also accommodate random sequences (possible to output random values).

For example, in the configuration of FIG. 8, if the counter 32-31 is incremented 1, 2, 3, . . . , then the counter output value can also transition 1, 2, 3 . . . or transition n, 2n, 3n, . . . . However, in the configuration of FIG. 9, by setting random values in the memory 33-3, for example, random values such as 13, 0, 2, . . . , or the like, can be output. Alternatively, operation such as set out in the following is also possible by feeding back the numerical values of the memory 33-3 to the input stage register section 31.
Computation in each computational timing×N (positive integer) is possible.
Operation whereby the operation mode for the next measurement period can be determined is also possible by, during respective measurement periods, comparing the threshold value of the mode (for example, ON/OFF mode) of the LNA 12 currently operating with the result of the output stage register 33-1 and determining whether or not operation mode transition conditions are met for half or more of the measurement period (namely integration is performed on the comparison results, and determination made).

According to the second exemplary embodiment, following (a) to (e) are enabled in addition to the first exemplary embodiment.

(a) Multi-bit control is enabled, operation controlling other than that by two values 0/1 can be performed, which enable more precise control. Devices controlled by analogue potentials can be used since control signals are converted into analogue values by the LPF 14 and the like.

(b) Since the control value can be selected using addressing by the counter 32-31 of the memory, under conditions of set latency (number of cycles) control other than setting a fixed value is possible. In an analogue device, not all characteristics are one-dimensional linear, and many result in curves, due to saturation and frequency characteristics and the like. Such phenomena can also be accommodated. Consequently, easy accommodation can be made in cases where conditions of use of the autonomous control unit is changed or the characteristics have changed due to changing to a different device.

(c) Further condition computations are possible using computation results, by feeding back output values of the counter 32-31 to the input stage registers 31-1 to 31-n that acquire vales.

(d) Due to (a) to (c) as set out above, for example, as well as optimal controlling of the characteristics of the device, optimal controlling of power consumption is also possible by adjusting the amount of electrical current.

(e) Problems that could not be anticipated during design can also be addressed after hardware manufacture, by performing adjustments to the adjustment register values according to the reception state, and the like.

### Exemplary Modifications

The present invention is not limited to the above exemplary embodiments, and various changes to the mode of use and modifications are possible. Examples of the sorts of changes to the mode of use and modifications are as set out in the following (i) and (ii).

(i) The configuration of the receiver may be changed to other configurations not shown in the drawings. For example, plural autonomous control units 30 may provided in parallel to each other, and the reception state may be controlled by control values output from these autonomous control units 30. Thereby, simultaneous parallel processing and other independent controls may be performed at the same time.

(ii) The present exemplary embodiments are applicable to any device in which given data in a communication device is autonomously acquired, and performs control of a control subject inside or outside of the device. In the exemplary embodiments, explanation has been given with terrestrial digital broadcasting as an example, however the present invention is applicable to communication devices in general, and enables control of distortion at the transmitting side, transmitting power, directional characteristics and the like in communication devices with a receiver. In particular, application can also be made to devices with control loops that can obtain good characteristics by controlling obtained data with precise values and at precise timings.

According to an autonomous control unit of the present invention the following points (i) to (iii) are enabled.

(i) Acquisition of a value (signal) for performing control at a given set timing is enabled, and the intended results for inputs can always be obtained by computation.

(ii) Since timing for renewal of computation results and performance of control can be controlled to be one or more given timings, the operation of the receiving system may be changed at an appropriate timing during reception processing.

(iii) Since computation is performed at a set (constant) latency (cycle number), the time period from obtaining a value for control up to the timing of actual performing control is always constant, and the intended computations and control are always carried out.

According to a receiver having an autonomous control unit of the present aspect, control of an application processor as conventionally carried out is not required, and appropriate power and receiving states can be generated autonomously.

What is claimed is:

1. An autonomous control unit comprising:
an input stage register section that comprises a plurality of input stage registers, and acquires, at a first timing, data indicating a given reception status of an incoming signal;
a computation section that performs comparison computation with respect to the data acquired by the input stage register section, performs logic processing of a set number of cycles of sequential control on the comparison computation result, and derives a logic processing result; and
an output stage register section that comprises at least one output stage register, and that outputs a control value from the logic processing result at a second timing.

2. The autonomous control unit of claim 1, wherein the first timing can be specified at a point in time when a reference frame timing when receiving the incoming signal, or a reference symbol timing, is shifted by a given time.

3. The autonomous control unit of claim 1, wherein at least one input stage register of the plurality of input stage registers acquires the value of another of the input stage registers.

4. The autonomous control unit of claim 1, wherein at least one input stage register of the plurality of input stage registers acquires the control value output from the output stage register.

5. The autonomous control unit of claim 1, further comprising a counter that counts the logic processing results and outputs the control value at a specific timing.

6. The autonomous control unit of claim 1, wherein, at the second timing, the output stage register renews the control value to be output.

7. The autonomous control unit of claim 5, wherein the counter comprises control inputs of increment, decrement, load-enable, and reset, and the counter is controlled by the computation section and outputs the control value which is multi-bit.

8. The autonomous control unit of claim 7, further comprising at least one memory in which random control values are stored, wherein the random control values are retrieved using the multi-bit control value for addressing.

9. The autonomous control unit of claim 7, wherein at least one input stage register of the plurality of input stage registers acquires the multi-bit control value.

10. The autonomous control unit of claim 1, wherein the autonomous control unit is programmable from the exterior.

11. A receiver comprising a single autonomous control unit of claim 1, or a plurality of the autonomous control unit of claim 1 disposed in parallel,
wherein the reception status is controlled by the control value output from the autonomous control unit.

12. The receiver of claim 11, further comprising a general purpose input-output port that, based on the control value output from the autonomous control unit, outputs a control signal for use in ON/OFF switching of a low noise amplifier that amplifies the incoming signal.

13. The receiver of claim 11, further comprising a pulse modulator that pulse modulates a multi-bit control value output from the autonomous control unit and outputs a digital signal for use in analogue control signal generation.
